(19) United States
(12) Patent Application Publication
(10) Pub. No.: US 2014/0211974 A1
(43) Pub. Date: Jul. 31, 2014

(54) Weatherproof Windscreen for Microphone

(71) Applicant: William J Pielsticker, Lodi, WI (US)

(72) Inventor: William J Pielsticker, Lodi, WI (US)

(21) Appl. No.: 13/749,876

(22) Filed: Jan. 25, 2013

(51) Int. Cl. H04R 1/08

(52) U.S. Cl. CPC H04R 1/086
USPC 381/359

(57) ABSTRACT

A sealed enclosure providing a microphone contained therein extended protection from the weather and some other outdoor hazards while not substantially altering the dynamic range of said microphone. The enclosure consists of a layer of liquid-water impermeable fabric, a layer of acoustical foam, a protective cage, and a wind noise dampening external cover. The enclosure is assembled around a microphone and a commercial foam windscreen, or around a custom high-wind foam windscreen first assembled around the microphone. As such, the weatherproof enclosure enables continuous use of boundary microphones and many other types and styles of microphones outdoors year round while supplementing the wind noise reduction of the enclosed foam windscreen.

### BACKGROUND OF THE INVENTION:

Since 1977, researchers and environmentalists have used the term “soundscape” to describe the “acoustic ecology” of a locale. Any effort to electronically monitor a soundscape, such as the audio environment of a particular geographic area or even one's backyard, would be best served by using one or more boundary microphones. Boundary microphones have a semi-omnidirectional pick-up pattern. Mounting a boundary microphone on a flat surface will augment the pick-up capability of the microphone (extends the boundary), but only in the direction above the surface. When mounted on a vertical surface, a boundary microphone will receive and transmit all audible sounds in the direction “above” that surface. When boundary microphones are used outdoors, vertical mounting enables the pickup of all sounds from ground to sky in front of the surface, and virtually no sounds from behind it. Boundary microphones also are especially well suited to transmit a wide range of frequencies from near and distant sources while not altering the frequency of distant sounds, typically a problem for conventional microphones.

Boundary microphones generally are intended for indoor use and not designed to be waterproof or water-resistant. Even with adequate protection from water, the boundary microphone would also need a robust windscreen for outdoor use. Boundary microphones generally have a cursory windscreen element, and lack an after-market choice of supplemental windscreens from suppliers like WindTech™.

Perhaps the first design for a waterproof boundary microphone is provided by Akino et al, 2008 (U.S. Pat. No. 7,471,802). By coating the microphone cover with small pieces of nylon via electrostatic flocking, then treating it with a waterproofing compound, the microphone is rendered waterproof. Akino also claims some wind noise dampening through the electrostatic flocking layer. While Akino's design is aimed at outdoor security monitoring, it is unclear how well this could be applied to locations fully exposed to the elements.

Akino's primary objective is to waterproof the boundary microphone. While that is also a key objective to another “weatherproof” microphone design (though not a boundary microphone), the design demonstrated by Davies in GB Pat. No. 2369522 (A) (2005) also seeks to minimize wind noise. While not the solution employed in this design, Davies acknowledges that a “particularly effective” means of reducing wind noise is using a foam rubber (or similar) windsock over the microphone. He also notes that problems arise should the foam windsock become waterlogged, limiting its utility for outdoor use.

Brief Summary of the Invention: The present invention is designed specifically to both reduce wind noise and to shield the enclosed microphone from liquid water. This invention employs a fully sealed liquid water-impermeable chamber for weatherproofing a microphone, in particular a boundary microphone. The enclosure surrounds a commercial (if available) or custom-made high-wind foam windscreen covering the top or the pick-up surface of the microphone. By including a portion of the cord or cable attached to the microphone within the enclosure the water protection is extended to the microphone plug. Finally, utilizing a breathable fabric to exclude liquid water enables use of the weatherproof windscreen in freezing environments without formation of frozen condensation within the enclosed microphone.

The sealed chamber includes one or more pieces of water-impermeable fabric seamed with a waterproof adhesive forming a continuous seal. The fabric is covered with a layer of acoustically neutral foam to prevent the wind from buffeting the fabric and inducing undesirable noise. To enhance the integrity of the fabric, it may be enclosed within a structure constructed to prevent damage by small animals. Finally, the assembly is covered by a suitable exterior fabric, preferably one that contributes to the wind-dampening capacity of the combined windscreens.

Outdoor testing of this windscreen enclosing a custom high-wind windscreen design (also detailed herein) enabled a boundary microphone to render the full range of outdoor sounds in both gusting and sustained direct winds up to 35 mph, without sacrificing audio quality in calm conditions. Real time analysis of the test microphone's sensitivity reveals some roll-off at frequencies great than 10,000 Hz, though within the ability of a good 3-band equalizer to compensate for.

This weatherproof windscreen is designed for use with a microphone in tandem with an internal windscreen, thereby providing water resistance as well as increased wind-dampening capacity. The present invention differs from prior art in enclosing a microphone and flexible foam windscreen within a sealed external windscreen. This design not only utilizes the known ability of foam windscreens to reduce wind noise, but can provide effective protection for boundary microphones and other styles of microphones and microphone-containing devices in many types of weather for extended periods of time with minimal impact on the sensitivity of the microphone.

### DETAILED DESCRIPTION OF THE INVENTION:

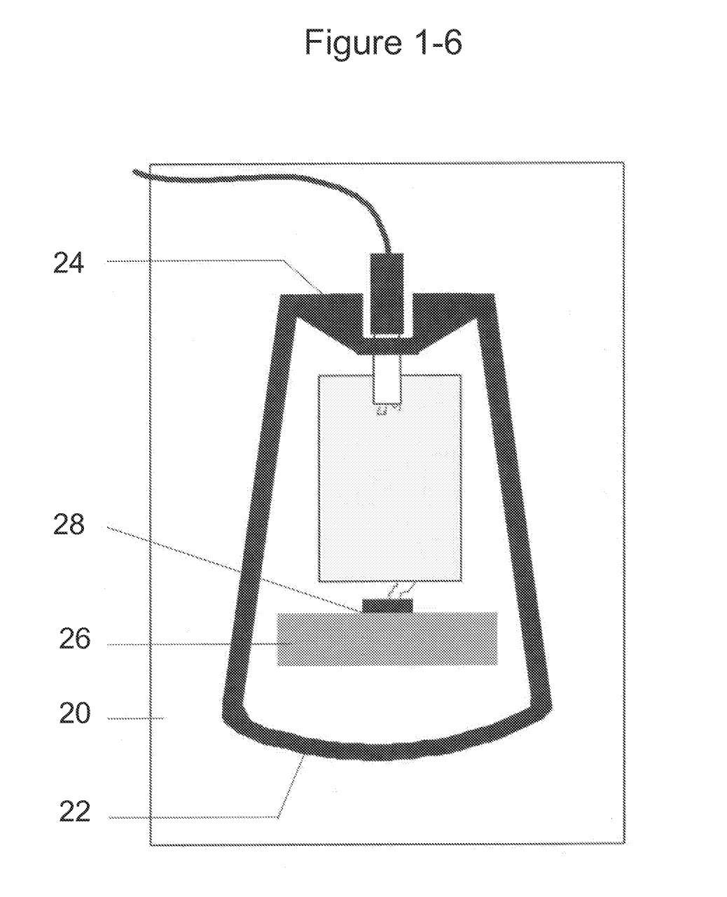

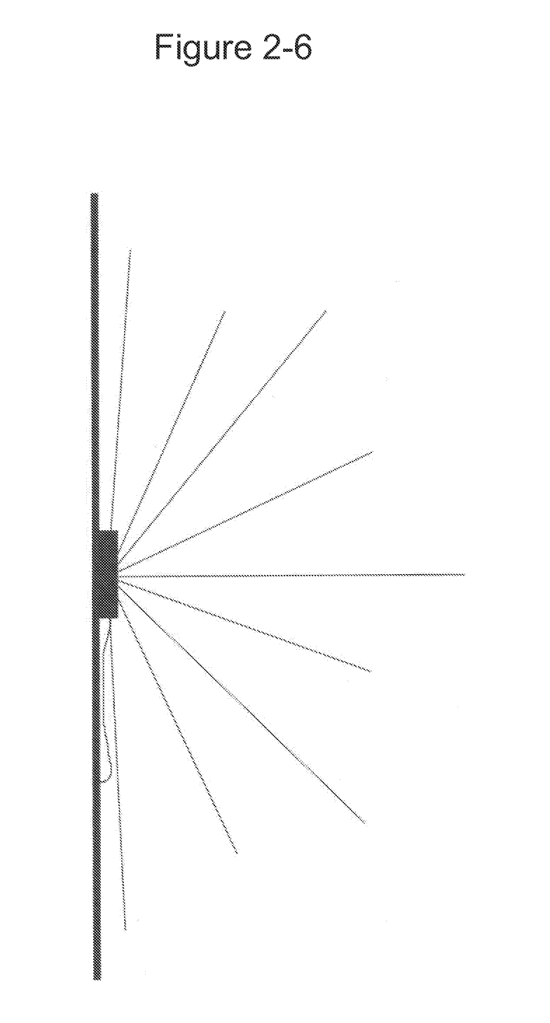

Depicted in FIG. 1 is a Peavey PSM-3 boundary microphone with a flat-bottomed housing viewed with its perforated metal cover removed. The boundary microphone's half-omnidirectional pick-up pattern (FIG. 2) allows a windscreen to be confined to the surface above the microphone body. As this common style of boundary microphone generally lacks any commercial windscreen options, a custom high-wind windscreen must be constructed. Accordingly, an internal base is configured for the microphone and inner foam windscreen 20.

The base material can vary but should be fairly rigid, thin, and flat. Preferably, a piece of 4-ply mat board 20 (but other thin materials can be used) is cut in a square, rectangle or another shape similar to the outline of the microphone housing, allowing enough room around the base of the of the microphone housing to anchor a layer of acoustic foam or ½″ min. from the closest point of the housing. The microphone is positioned on the base centrally from left to right. It is positioned ½″ from the “front” or leading edge 22 of the housing. Additionally, the base should extend far enough beyond the back or trailing edge 24 of the microphone to provide protection to the microphone cable's point of attachment to the microphone body.

With this particular microphone design, the first element of wind dampening material may be fashioned from a small piece of ½″ acoustically neutral foam (hereinafter, acoustic foam), available from WindTech through Full Compass Audio and other suppliers, under product name WS-2, fitted and attached beneath the microphone cover 26 in a manner that completely covers the condenser's surface 28 to minimize sibilance, i.e. the noise from direct wind contact with the condenser.

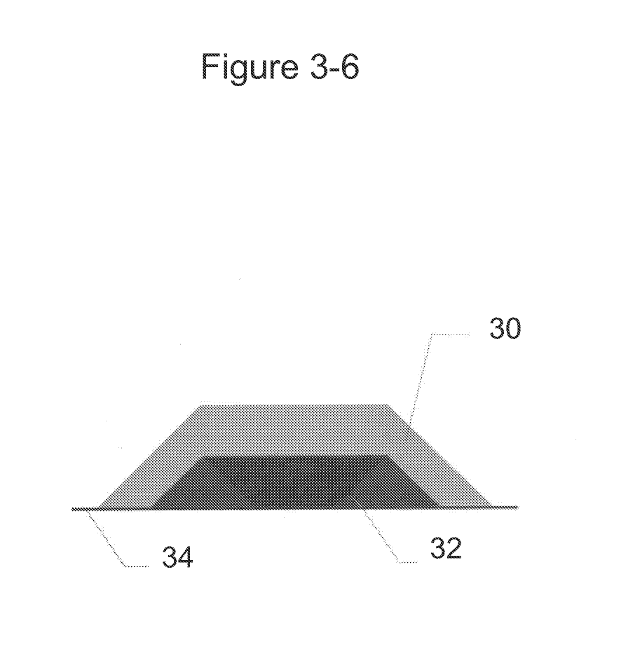

The main body of the inner windscreen, FIG. 3, consists of a piece of ½″ acoustical foam 30 cut to fit snug over the microphone's housing 32 and attached to the base 34 using a fast adhesive material, preferably hot glue. The void between the first foam element and the microphone cover becomes a dead air space when this second foam element is attached. This completes the inner windscreen. If a commercial windscreen is available, it would be mounted over the microphone and, if necessary, attached to an inner base.

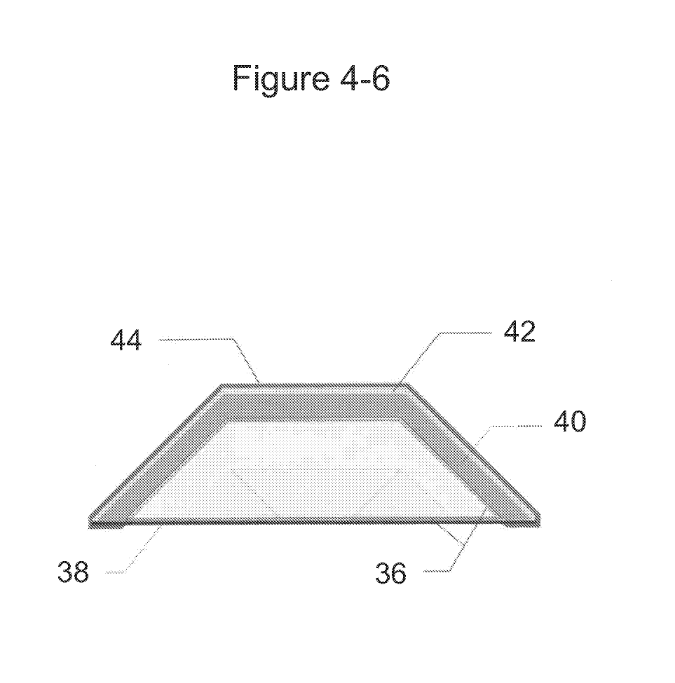

The inner layer of the external windscreen 36 (FIG. 4) is formed using a quantity of sound-conducting water-impermeable flexible fabric such as UV-resistant spun polyethylene sheeting (Tyvek®) cut sufficient to completely and snuggly enclose the face of the top foam layer and to fold smoothly over the edges of the internal base 20 with enough overlap to facilitate sealing the seams. The fabric is folded around the windscreen and base so that all seams are on reverse side of the base. A waterproof adhesive for bonding HDPE, preferably Tam Tech® adhesive available from Tamarron Technology, is applied in a continuous bead within each overlap of the fabric as well as around the cord where it exits the enclosure. When the adhesive has cured, the microphone and internal windscreen are sealed within a liquid water-impermeable enclosure. As the enclosure passes water vapor and similar substances, it also minimizes the potential for condensation and ice formation inside the enclosure when used in temperatures below 32° F.

The sealed enclosure is now attached to an external base 38 made of a thin and fairly rigid material (preferably, aluminum sheeting of 0.0115 gauge). This external base will share a similar outline but preferably measures ⅝″ longer and wider than the inner base. The sealed enclosure is fixed in the center of the external base using a fast-acting adhesive. To provide additional wind-noise dampening as well as preventing wind from directly contacting the impermeable material and causing noise, a layer of ¼″ acoustical microphone foam 40 (WindTech product WSF-1) is cut to fit in close contact with the fabric when attached to the external base. The foam is attached to the upper surface of the base using fast acting adhesive, preferably hot glue or another product.

When the windscreen is intended for extended outdoor use, the liquid water-impermeable fabric should be protected from damage by small animals. A cage 42 is pieced together from appropriately sized pieces of ¼″ mesh material, here 23 ga. 4×4 galvanized hardware cloth. The sections of this cage are joined together, here with ⅜″ c-rings crimped tight, forming a sound conducting protective barrier around the external layer of microphone foam while remaining at least ¼″ away from the impermeable fabric. This cage is placed on the outer base while resting on or above the outer foam layer and fixed to the aluminum base using an appropriate adhesive. This combination substantially reduces the likelihood of small animals compromising the integrity of the liquid water-impermeable fabric.

Lastly, an outer cover 44 is assembled preferably from a single piece of a sound-conducting fabric (here, sections of acrylic faux fur fabric) and sized to overlap the bottom of the external base by ½″ on all sides. Using a material with a dense base pile, preferably Arctic Fox available from Mendel's Fabrics or similar provides an important final wind dampening layer (reducing “booming”) while shielding the assembly from windblown dust, sand and debris. The corners of the cover are sewn to the point of overlap with the base. The cover is then fitted over the cage. Before the overlap is attached to the cover, an apparatus for attaching the assembly to the mounting surface (partially crimped c rings, wire, or similar) may be attached to the wire cage, using as points of attachment the wire mesh on either corner of the cable end of the windscreen.

The outer cover is attached to the base using heavy duty double-stick tape positioned around the outside of the bottom of the base. The protective strips on the tape are removed and the overlapping material is folded over. Once fixed in place and trimmed, the edges of the outer cover are sealed to the base using a permanent waterproof adhesive, preferably Lexel caulk.

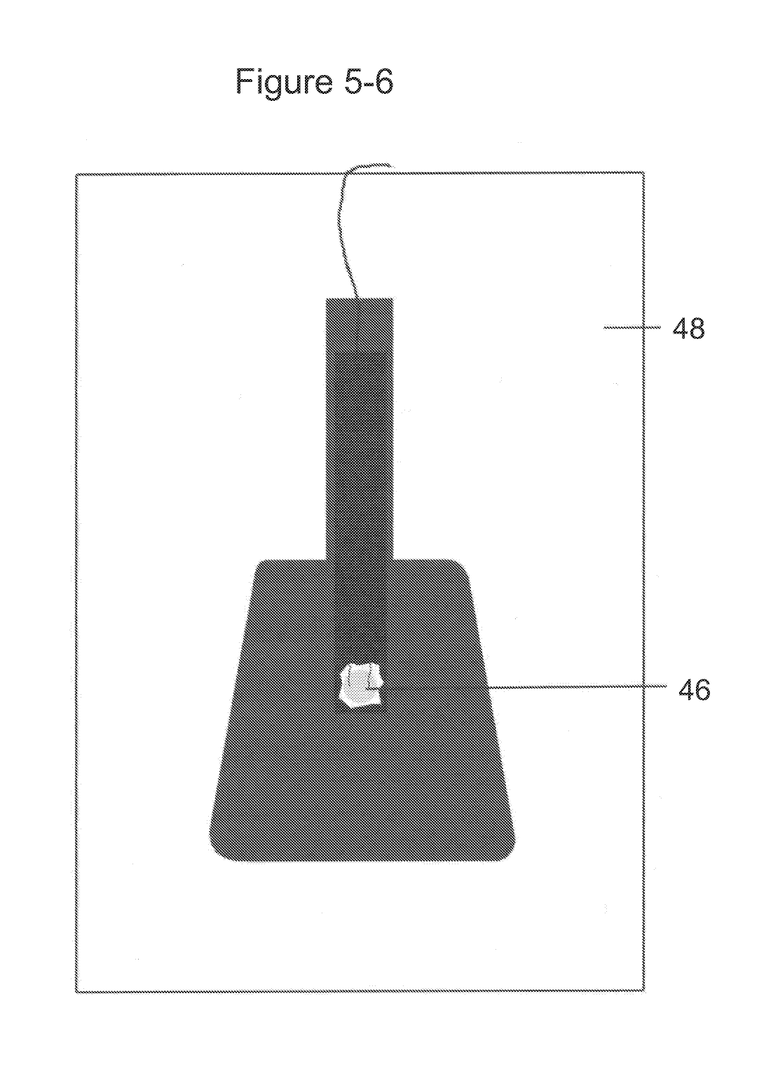

FIG. 5 depicts another common style of boundary microphone; one mounted on a Paddle—here the Crown PZM-185. In this top view, the cutaway reveals the location of the electret condenser 46, which is mounted on the under-surface of the microphone housing. This prevents use of a small piece of acoustic foam as the first layer of wind-dampening material. Instead, the base for the high-wind windscreen 48 is sized to accommodate two layers of ½″ acoustical foam plus the ¼″ min. for the dead air space. In either circumstance, a minimum of 1¼″ of acoustical foam enclosed by a cover of wind-dampening material in conjunction with a dead air space is needed to effectively dampen wind noise in winds up to 35 mph.

This design is optimized for a boundary microphone. The thin base materials are designed to minimize the elevation from the surface it is mounted on thereby maximizing the sound-reflecting properties of the larger surface. The weatherproof windsock is not completely waterproof. It remains subject to physical transfer of water across the liquid-water impermeable membrane through close contact. Mounting the microphone vertically minimizes the likelihood of physical infiltration across the membrane. This reflects the tendency of rain and snowmelt to follow the contours of the outer cover and to run off rather than soak in. This tendency is enhanced by maintaining physical separation between the cage elements and the foam covering the liquid-impermeable fabric. Additional protection may be obtained by applying two or more layers of silicone-based or other waterproofing treatment to the fabric cover.

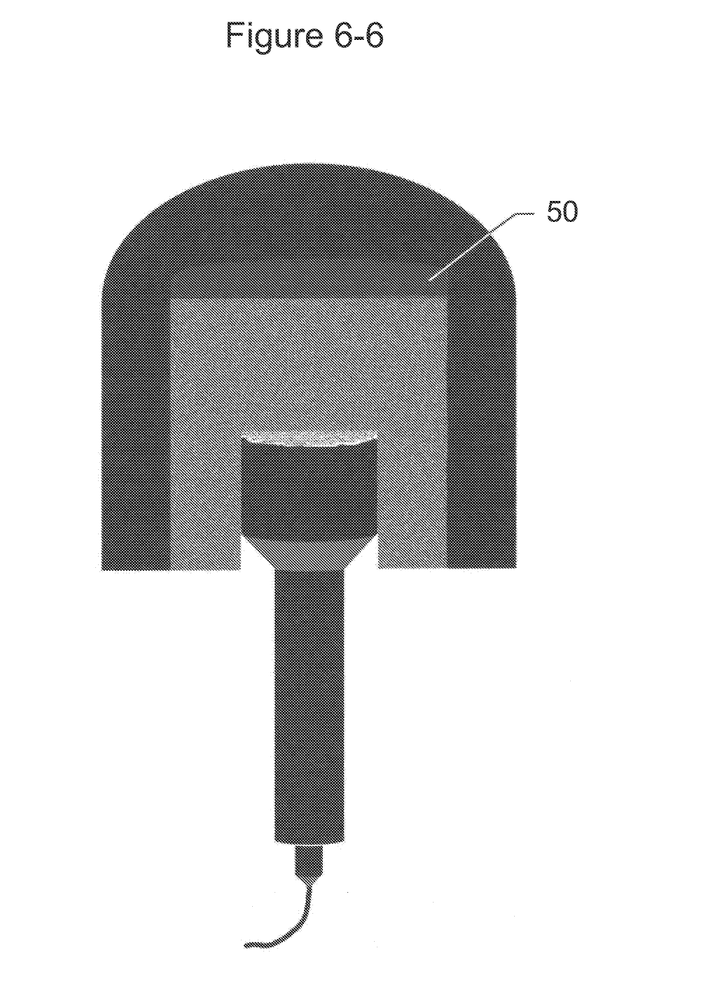

Should it be desired, a weatherproof windscreen can be assembled to fit other types of microphones. FIG. 6 illustrates a hand held microphone fitted with a high wind windscreen, preferably WindTech Ultra Series US-1 or similar. Already incorporating a dead air space 50 the liquid water-impermeable fabric is placed directly on the commercial foam windscreen. The weatherproof windscreen would be completed in much the same manner as demonstrated for boundary microphones. In this instance, the water-impermeable fabric could be sealed around the foam and the microphone handle, or it could enclose the handle and plug as well.

Certain modifications of this design would come within the scope of this invention.

1. A weatherproof windscreen for enclosing an inner windscreen and at least partially enclosing a microphone, comprising: a sealed chamber of water-impermeable material;
two or more layers of protective material external to the sealed chamber which may include a layer of wind-dampening material, and an outer cover of wind dampening material.

2. The windscreen of claim 1 and further comprising a microphone enclosed in a foam windscreen.

3. The windscreen of claim 1, wherein the impermeable material is flexible.

4. The windscreen of claim 1, wherein the impermeable material is a fabric.

5. The windscreen of claim 1, wherein the impermeable fabric is a non-woven material.

6. The windscreen of claim 1, wherein the impermeable fabric is made of flashspun HDPE fibers.

7. The windscreen of claim 1, wherein the impermeable fabric is DuPont Tyvek.

8. The windscreen of claim 1, wherein the seams of the impermeable fabric are permanently sealed.

9. The windscreen of claim 1, wherein the seams of the impermeable fabric are sealed with a waterproof adhesive.

10. The windscreen of claim 1, wherein the seams of the impermeable fabric are sealed with an adhesive for bonding HDPE.

10. The windscreen of claim 1, wherein the seams of the impermeable fabric are sealed with TamTek Adhesive.

11. The windscreen of claim 1, wherein one layer of protective material includes open cell foam.

12. The windscreen of claim 1, wherein one layer of protective material includes acoustically neutral foam.

13. The windscreen of claim 1, wherein one layer of protective material is WindTech SonicFoam.

14. The windscreen of claim 1, wherein one layer of protective material prevents some means of compromising the integrity of the impermeable fabric.

15. The windscreen of claim 1, wherein the layers of protective material minimally alter the original sound quality of the enclosed microphone.

16. The windscreen of claim 1, wherein the protective materials substantially reduce potential damage to the impermeable chamber by small animals.

17. The windscreen of claim 1, wherein the outer layer of protective material consists of one or more sections of ¼″ mesh hardware cloth.

18. The windscreen of claim 1, wherein the hardware cloth forming the outer layer of protective material is joined on all sides.

19. The windscreen of claim 1, wherein the hardware cloth forming the outer layer of protective material is joined using c-rings.

20. The windscreen of claim 1, wherein the outer layer of protective material may be formed by a combination of metal sheeting and hardware cloth joined mechanically or with permanent adhesive.

21. The windscreen of claim 1, wherein the external cover includes a seamed wind-dampening fabric.

22. The windscreen of claim 1, wherein the external cover includes a seamed dense pile fabric.

23. The windscreen of claim 1, wherein the external cover includes a seamed “faux fur” fabric with a dense pile which may or may not have longer accent “hairs.”

24. The windscreen of claim 1, wherein two or more points of attachment for hanging or mounting the windscreen are included.

25. The windscreen of claim 1, wherein two or more points of attachment includes partially crimped c-rings joined to the outer layer of protective material.

26. The windscreen of claim 20, wherein the outer layer of protective material includes a firm surface providing an alternate means of attaching the windscreen to a surface.

26. The windscreen of claim 20, wherein the outer layer of protective material includes aluminum sheeting.

28. The windscreen of claim 20, wherein the alternate means of attaching the windscreen to a surface is with hook and loop fasteners.

29. The windscreen of claim 1, wherein in combination with an internal high-wind windscreen the enclosed microphone can effectively render sounds from its environment in winds of up to 35 mph.

30. The windscreen of claim 1, wherein in combination with an internal windscreen, minimally alters the original sound quality of the enclosed microphone.
